(19) United States
(12) Patent Application Publication
(10) Pub. No.: US 2018/0297904 A1
(43) Pub. Date: Oct. 18, 2018

(54) OLIGOSACCHARIDES AS STIMULATORS OF PLANT GROWTH IN ALREADY GERMINATED PLANTS AND METHOD FOR OBTAINING SAID OLIGOSACCHARIDES

(71) Applicants: UNIVERSIDAD POLITECNICA DE MADRID, Madrid (ES); UNIVERSITAT HAMBURG, Hamburg (DE)

(72) Inventors: Marta BERROCAL LOBO, Madrid (ES); Jose Alfonso DOMINGUEZ NUNEZ, Madrid (ES); Inmaculada ARANAZ CORRAL, Madrid (ES); Elisabeth A. MAGEL, Hamburg (DE); Alexander WINKLER, Hamburg (DE)

(73) Assignees: UNIVERSIDAD POLITECNICA DE MADRID, Madrid (ES); UNIVERSITAT HAMBURG, Hamburg (DE)

(21) Appl. No.: 15/574,050

(22) PCT Filed: May 13, 2016
(86) PCT No.: PCT/ES2016/070366

§ 371 Date: Nov. 14, 2017

(30) Foreign Application Priority Data
May 14, 2015 (ES) P201530657

(51) Int. Cl. C05C 11/00; C08B 37/08

(52) U.S. Cl. CPC C05C 11/00; C08B 37/003

(57) ABSTRACT

The invention relates to using oligosaccharides as stimulators of plant growth in already germinated plants and methods for obtaining said oligosaccharides. The invention particularly relates to using oligosaccharides comprising N-acetyl glucosamine and glucosamine as stimulators of plant growth in already germinated plants, where the percentage of N-acetyl glucosamine in said oligosaccharides is 100% and the length of said oligosaccharides is between 1 and 6 monosaccharides. The invention particularly relates to methods for obtaining said oligosaccharides, comprising: (a) resuspending chitin with a percentage of N-acetyl glucosamine of between 85% and 100% in water, (b) heating the resulting composition to a temperature between 120 and 180° C. for a duration between 20 and 40 minutes and leaving to cool to room temperature, and (c) sonicating the resulting composition at a power between 50 and 60 Hz for a duration between 5 and 120 minutes at a temperature between 20 and 25° C.

### FIELD OF THE INVENTION

The present invention related to the use of acetylated oligosaccharides derived from chitin, specifically oligosaccharides with a length between 1 and 6 monosaccharides and a N-acetyl glucosamine of 100% as fertilisers. Oligosaccharides can be used alone or mixed with other insoluble oligosaccharides or with fertilisers, whether in solid state or in a resuspension. The present invention also relates to a method for obtaining a fertiliser for plants composed of a mixture of oligosaccharides with between 1 and 6 monosaccharides with a level of acetylation of 100% based on chitin, which comprises heating and sonication.

### BACKGROUND OF THE INVENTION

Chitin is the second most abundant polysaccharide in nature, after cellulose, it is a biopolymer with a high molecular weight, composed of glucose, rich in carbon and amino groups, which are linked forming N-acetyl glucosamine and glucosamine in a variable proportion, which gives it a high percentage of nitrogen and carbon in the composition thereof. When the amount of glucosamine (non-acetylated groups) is sufficiently high, the polymer becomes soluble in aqueous acidic mediums and is given the name chitosan (approximately, this takes place when the percentage of glucosamine is 60% or higher).

Among the very diverse alternatives that have been used to date as fertilisers, the use of natural biopolymers derived from chitin, which are soluble and with a high molecular weight can be found; however, the use and commercialisation thereof as a fertiliser has not spread, perhaps due to its known properties as plant defense activators and, therefore, activators of stress in plants. The activation of stress in plants is commonly associated with an inhibition of plant growth and this is why both compounds have been more commonly used as pesticides and accompanying elements in fertilisers (Khoushab F et al. Chitin research revisited. Mar Drugs. June 28; 8(7):1988-2012; Ramirez M. A et al. (2010). Chitin and its derivatives as biopolymers with potential agricultural applications. Biotechnol. Appl. December; 27:4; Zhang J et al. (2010). Plant immunity triggered by microbial molecular signatures. Mol Plant. 3(5): 783-93).

Chitosan, as well as chitin, are used in laboratories and crops as activators of the defense response in plants, due to the fact that chitin is the main component in both the exoskeleton of insects and the spores of a high percentage of phytopathogenic fungi. The effect that both chitosan and chitin with high molecular weight have on plants, activating at a molecular level the innate immunity and processes related to biotic stress is well known (Povero G et al. (2011). Transcript profiling of chitosan-treated Arabidopsis seedlings. J Plant Res. 2011 September; 124(5):619-29; Zhang J. et al. (2010). Plant immunity triggered by microbial molecular signatures. Mol Plant. 3(5): 783-93; Ramonell, K. M. et al. (2002). Microarray analysis of chitin elicitation in Arabidopsis thaliana. Molecular Plant Pathology 3(5): 301-311; Ramonell, K. et al. (2005). Chitin: An elicitor which induces genes implicated in Powdery Mildew Defense responses. Plant Phys. 138:2; Berrocal-Lobo M et al. (2010). ATL9, a RING Zinc Finger Protein with E3 Ubiquitin Ligase Activity Implicated in Chitin and NADPH Oxidase-Mediated Defense Responses. PLoS ONE 5(12): e14426). Diverse studies have determined that chitin fragments with a length of 8 monomers are specifically recognized and have a greater affinity through receptors capable of activating the plant immune response (Miya A et al. (2007). CERK1, a LysM receptor kinase, is essential for chitin elicitor signaling in Arabidopsis. Proc Natl Acad Sci USA. December 4; 104(49):19613-8; Liu T et al. (2012). Chitin-induced dimerization activates a plant immune receptor. Science. June 1; 336(6085):1160-4. doi: 10.1126/science.1218867; Akamatsu A et al. (2013). An OsCEBiP/OsCERK1-OsRacGEF1-OsRac1 module is an essential early component of chitin-induced rice immunity. Cell Host Microbe. April 17; 13(4):465-76; Hayafune M et al. (2014). Chitin-induced activation of immune signaling by the rice receptor CEBiP relies on a unique sandwich-type dimerization. Proc Natl Acad Sci USA. January 21; 111 (3):E404-13; Cao Y et al. (2014). The kinase LYK5 is a major chitin receptor in Arabidopsis and forms a chitin-induced complex with related kinase CERK1. Elife. October 23; 3. doi: 10.7554/eLife.03766). It has been seen that this recognition activates a response in plants related to the stress caused by phytopathogens, an occurrence that has been noted in several plant species such as rice, tomato, wheat, melon, soy or holm oak (Ebel, J. et al. (1994). Elicitors of plant defense responses. Int. Rev. Cytol. 148:1-36; Shibuya, N. et al. (1996). Localization and binding characteristics of a high-affinity binding site for N-acetylchitooligosaccharide elicitor in the plasma membrane from suspension-cultured rice cells suggest a role as a receptor for the elicitor signal at the cell surface. Plant Cell Physiol. 37:894-898; Stacey G et al. (1997) Chitin Recognition in rice and legumes. Plant Soil 194: 161-169; Yamada, A. et al. (1993) Induction of phytoalexin formation in suspension-cultured rice cells by N-acetylchitooligosaccharides. Biosci. Biotech. Biochem. 57: 405-409; Felix, G. et al. (1993). Specific perception of subnanomolar concentrations of chitin fragments by tomato cells: Induction of extracellular alkalinization, changes in protein phosphorylation, and establishment of a refractory state. Plant J. 4:307-316; Roby, D. et al. (1987). Chitin oligosaccharides as elicitors of chitinase activity in melon plants. Biochem. Biophys. Res. Commun. 143:885-892; Day, R. B. et al. (2001). Binding site for chitin oligosaccharides in the soybean plasma membrane. Plant Physiol. 126:1162-1173; Nishizawa, Y. et al. (1999). Regulation of the chitinase gene expression in suspension-cultured rice cells by N-acetylchitooligosaccharides: Differences in the signal transduction pathways leading to the activation of elicitor-responsive genes. Plant Mol. Biol. 39:907-914). Therefore, both chitin and chitosan with a high molecular weight have been used mixed or separately, even combined, accompanying other substance as activators of defense and stress in plants.

The present invention relates to obtaining a fertilizer composed of a mixture of acetylated chitin in a high percentage and partially digested, composed of small fragments which gives it an insoluble nature (and therefore non-contaminating) and enables greater accessibility to its glucose content and acetyl groups than the aforementioned mixtures of chitin in its original polymeric state, preventing the activation of stress in plants and the need for plants or other microorganisms or organisms from the soil to release chitinases for the prior hydrolysis of this compound for the absorption and digestion thereof.

A high number of living organisms contain chitin in their structure (crustaceans, nematodes, insects, cephalopods, fungi, algae, etc.) and many microorganisms of the soil and marine environment have chitinoclastic or chitinolytic capacity and use chitin as the main source of carbon and nitrogen for the growth thereof. These chitinolytic microorganisms, whether from land or marine environment, mainly belong to the genera Proteobacteria, Bacteroidetes, Actinobacteria and Firmicutes; they are capable of degrading large chitin polymers from the structures of other organisms (spore coat, crustacean shells, insect skeletons, cephalopod skeletons, etc.), transporting small chitin derivatives to the inside and using them as carbon and nitrogen sources in their intermediate metabolism. The molecular mechanism through which these organisms use chitin as a carbon and nitrogen source is well known (LeCleir, G. R. et al. Chitinase Gene Sequences Retrieved from Environment-Specific Distributions. 2004, 70(12):6977. DOI:Appl. Environ. Microbiol. 10.1128/AEM.70.12.6977-6983.2004).

Moreover, the possible mechanism of use of these chitin biopolymers by plants is unknown at a molecular level, although specific receptors thereof are known, as well as ammonium or glucose carriers, which are the main components of said biopolymers. It is well known that the plants recognize the chitin with high molecular weight and release chitinase enzymes that cause the degradation thereof, preventing the growth of the attacking pathogen, the resulting fragments serve as food for the microflora of the soil.

The use of chitin or chitosan, exclusively in the form of a polymer with a high molecular weight has two disadvantages for the use thereof on plants, the first is mainly due to the fact that despite being degraded by the microorganisms of the soil and marine environment, as cited above, these compounds are recognised by the plants as potential components of the walls of fungi, nematodes and insects, thus inducing a plant defense response associated to the production of stress with the resulting inhibition of plant growth. This response to stress has been confirmed more recently, to a greater extent, by means of the study of diverse genetic profiles obtained from the genome of plants treated with chitin in its original polymeric state, which is the form exclusively used as a pesticide and fertilizer. In these cases it has been noted that groups or clusters of genes are inducing an activation of a defense response related to biotic stress and the presence of fungi (Ramonell, K. M. et al. (2002). Microarray analysis of chitin elicitation in Arabidopsis thaliana. Molecular Plant Pathology 3(5): 301-311; Berrocal-Lobo M et al. (2010). ATL9, a RING Zinc Finger Protein with E3 Ubiquitin Ligase Activity Implicated in Chitin and NADPH Oxidase-Mediated Defense Responses. PLoS ONE 5(12): e14426).

As a result of these data, it is to be expected that the beneficial activity of these biopolymers, with a high molecular weight, is attributed to the positive effect they cause on the development of the biomass of the chitinolytic microorganisms of the soil, rather than the direct effect that they may cause on the treated plants.

The second disadvantage of the compounds with a high molecular weight is that the most common derivative, chitosan, due to being deacetylated, is soluble in acids and is administered diluted in said acids, with the resulting contamination caused by both leaching and evaporation. This polymer is also well known due to its activating effect of stress in plants (Povero G et al. (2011). Transcript profiling of chitosan-treated Arabidopsis seedlings. J Plant Res. 2011 September; 124(5):619-29).

Chitin in nature appears linked to proteins, mineral salts and pigments that are removed during the extraction thereof. 100% acetylated chitin is uncommon in nature, being extracted from diatoms (Thalassiosira fluvialitis and Cyclotella cryptica). Chitosan is only naturally present in some fungi. Commercial chitosan samples are prepared using chemical deacetylation of the chitin from the exoskeleton of crustaceans. Deacetylation rarely fully takes place and, therefore, variable amounts of N-acetyl glucosamine appear in the structure of the chitosan. The chitin extraction process and the chemical preparation of chitosan from fungus mycelium or crustacean shells is well known, and includes various consecutive phases of washing and homogenisation, demineralisation with hydrochloric acid, deproteinisation with sodium hydroxide, extraction with acetone and subsequent drying, and the deacetylation process of the chitin to obtain chitosan also requires a second treatment with sodium hydroxide. The method described in the present invention does not require the use of acids, given that acetylated fragments are obtained from acetylated chitin in a high percentage, although the mixture obtained can serve to be subsequently deacetylated for other uses. It is for this reason that in the method of the present invention, the prior solubilisation of the chitin is not required to obtain the fertilizer.

The variability of the chitin is due to the natural origin thereof and the source for obtaining it and the physical and chemical properties thereof can vary depending on the age of the individual or the physiological state thereof. This variability includes various parameters such as the relation between acetylated and deacetylated units, the distribution thereof along the chain, the crystalline structure thereof and the length of the chain that makes it up. The source chitin also varies depending on the proportion of proteins, mineral salts and/or pigments or other compounds associated to the same and present in the individual at the time of extraction.

The extracted crustacean chitin has a α-type crystalline structure while the isolated squid pen chitin has a β-type crystalline structure. A third γ-type polymorphic form has been described, although it is not clear if it really exists or appears due to the processing to obtain chitin. β-chitin has a more open structure that makes it more accessible to attack by reactive agents and enzymes and in the composition thereof it associates to a greater percentage of proteins than the α form.

Inorganic nitrogen compounds have been used since the 20th century in essentially all the industrial fertilizers used today. The over-exploitation of agroforestry soil has led to the loss of the organic nitrogen content of soils and this has led to the uncontrolled and disproportionate use of inorganic nitrogen as a fertilizers and the accumulation thereof until saturation, both in land ecosystems and coastal and oceanic areas.

Mainly as a result of the solubility of these compounds, only a third of the nitrogen provided by inorganic fertilizers is assimilated by the crops, the rest is released into the atmosphere and runoff water. The main effects caused by nitrification and denitrification include, among others, the increase in greenhouse gas emissions, mainly nitric oxide in the form of gas, the acidification of the crop soil and the eutrophication of ecosystems, with the resulting production of both forest and agricultural dead areas. Within these changes and under these conditions, the biodiversity of the soil, as well as that of the marine environment, reduces or even disappears, the agroforestry systems being the most affected. As a result of agricultural over-exploitation, high amounts of nutrients are removed from the natural nitrogen cycle, meaning that the natural regeneration of the environment is impossible.

Currently, the high levels of nitrogen pollution and the over-exploitation of agroforestry soil are so high that the urgent search for new alternatives to the current inorganic fertilizers is necessary. In this vein, the present invention enables an organic fertilizer that does not pollute the medium, due to the insoluble nature thereof, to be obtained based on highly acetylated biopolymers with a low molecular weight, by means of a simple and cheap protocol, based on chitin and/or the derivatives thereof.

### DESCRIPTION OF THE INVENTION

The present invention provides the use of oligosaccharides composed of N-acetyl glucosamine as stimulators of plant growth in already germinated plants, where the percentage of N-acetyl glucosamine in said oligosaccharides is 100% and where the length of said oligosaccharides is between 1 and 6 monosaccharides, hereinafter use of the invention.

The oligosaccharides have a length between 1 and 6 monosaccharides, which means that they do not generate plant stress caused by polymers with a high molecular weight. This mixture of oligosaccharides can be combined with those with a high weight or used without being combined.

Oligosaccharides are insoluble, which means that they do not pollute the environment since they do not leach or evaporate, remaining in the soil until they are degraded or consumed.

The present invention also provides a method for obtaining oligosaccharides composed of N-acetyl glucosamine as stimulators of plant growth in already germinated plants, where the percentage of N-acetyl glucosamine in said oligosaccharides is 100%, where the length of said oligosaccharides is between 1 and 6 monosaccharides and where the method comprises the following stages:
(a) resuspending chitin (previously homogenised) with a percentage of N-acetyl glucosamine of between 95% and 100% in water,
(b) heating the resulting composition of stage (a) to a temperature of between 120 and 180° C. for a duration of between 20 and 40 minutes and leaving to cool to room temperature, and
(c) sonicating the resulting composition of stage (b) at a power of between 50 and 60 Hz for a duration of between 5 and 120 minutes at a temperature of between 20 and 25° C., hereinafter method of the invention.

The chitin used in stage (a) of the method of the invention can be (preferably, must be) homogenized with a mortar and/or mill, or industrial grinder until a homogenous mixture with a mealy texture is obtained. Depending on the origin of the chitin, it may be necessary to carry out a prior deproteinisation, demineralisation, discolouration or another additional purification process that does not require the solubilisation thereof. The chitin of stage (a) can come from any type of organic or industrial material that contains chitin or chitosan and that has been modified until acetylated chitin of between 95% and 100% is obtained.

In order to ensure a mixture enriched with oligosaccharides with a low molecular weight that are insoluble is obtained, the chitin must be acetylated between 95 and 100%. If the proportion of initial acetylated chitin is lower than 50%, forming chitosan, the finally obtained product will be different from that obtained in the method of the invention. Therefore, in this case the chitin may also require a prior acetylation or another additional modification process.

In stage (a) of the method of the invention, the chitin can be resuspended in a solution of distilled water with a “MiliQ” type purity level, which has an initial pH value preferably of between 5-8. The final pH value of the suspension is that which is provided by the product in said suspension. This pH value can be adjusted by adding a pH regulator. For example, it can be adjusted to a pH value of 5 to 6. The pH value does not affect the product in this range, or the detected activity of the final mixture.

The temperature during stage (c) of the method of the invention must not exceed 25° C. The modification of this temperature can affect the properties of the product.

In stage (c) of the method of the invention, an Ultrasons-H-type sonicator, industrial sonicator or similar apparatus can preferably be used, using the recommended power and temperature.

Another embodiment is the method of the invention, where in stage (a) the chitin is resuspended at a concentration between 0.04 to 4 g/l.

Another embodiment is the method of the invention, where the resulting composition of stage (c) is subjected to a drying process.

The resulting composition of stage (c) can be dried using different methods, such as rotary evaporation, evaporation or drying at a high temperature for the subsequent use thereof, the drying method not affecting the final composition of the mixture. The drying enables both the transportation and storage of the mixture, as well as the direct treatment of the medium to be treated with the mixture directly in the solid state thereof if required.

The product obtained by the method of the invention can be used in a solid state or in a resuspension in distilled water, as it has been obtained and given that it is in sterile conditions, it can be stored without suffering contaminations, both at room temperature and in a refrigerator at 4° C. It can also be resuspended in other liquids as long as they do not affect the physical and chemical properties thereof.

It is recommended that the product obtained through the method of the invention be stored at a temperature between 4° C. to 25° C., given that this temperature range does not affect the properties of the product, whether in a resuspension or solid state.

The product obtained can also be mixed in different proportions with chitin and chitosans with a high and low molecular weight in order to obtain the desired effects, as well as with microorganisms, substances or products on the existing market, for very diverse uses, having to maintain the chemical and physical properties if the effect described in the present invention is to be obtained.

The method of the invention enables a fertilizer to be obtained that could be obtained from any of the chitins from diverse origins cited above, including chitin or chitosan from industrial use, as long as the initial compound is that which is described in the present invention. Therefore, the method enables the chitin and the derivatives thereof to be recycled for the subsequent use thereof as organic fertilizers.

The method of the invention enables biopolymers rich in organic nitrogen, insoluble and with a low molecular weight to be obtained that can be directly metabolized by the chitinolytic microorganisms, providing them with a partially “digested” food source. The presence of these biopolymers in the medium causes, as a result, the stimulation of plant growth, which means that these biofertilizers, obtained by means of the method of the invention, are excellent restorers of the biomass of over-exploited soils and degraded soils, such as for example, over-exploited agricultural lands that are low in nitrogen or unused, or burned forest soils or that have been degraded by other causes.

The biofertilisers obtained using the method of the invention are biocompounds in a partially digested state; the organisms that use them as a carbon and nitrogen source do not need to digest them by means of releasing chitinolytic enzymes, which enables them to make significant energy savings. Additionally, they contain organic nitrogen, they are obtained by means of a low cost process and, lastly, they are insoluble and, therefore, they are not released into the atmosphere or dissolved in the water, they do not contain acidic substances that can alter the composition of the environment either, in addition to being metabolized with a high yield by and at the rate required by the microorganisms of the soil.

As mentioned above, the product obtained by the method of the invention, due to having a low molecular weight, is not recognized by the plants as a component of the structure of the phytopathogen and, therefore, does not generate the response to stress that these produce, this response to stress generally being associated to the inhibition of plant development.

Given the great versatility in the possible uses thereof, the application method of the product can vary greatly, whether in a suspension, in a drip irrigation solution, spraying, soil-injection, deep root fertilisation or dry application, whether compacted or not. The concentration of the product can vary depending on the use, depending on the desired effect and the plant species, cell culture, microbiology, substrate, solution, etc. where the product is applied.

The product obtained by the method of the invention can be used as biofertilizer on any type of substrate or known growing medium, as a carbon and nitrogen source of several organisms, as well as an industrial product for several pharmacological and chemical applications.

The combination of the product obtained by the method of the invention is possible with other commonly used compounds and organic or inorganic fertilizers and with a high nitrogen, carbon or potassium content such as guano from birds, bats, etc. or other forms of administration of urea, fish meal, horn and bone meal, blood from meat products, feather meal, manure from different origins, alfalfa, sewage sludge, sawdust, compost from worms and/or bacteria, marine algae extracts, straw, etc.

Patents have recently been published on the preparation of materials based on chitin and chitosan with the aim of producing bioplastics (Fernandez J G et al. (2014). Manufacturing of Large-Scale Functional Objects Using Biodegradable Chitosan. Bioplastic Macromol. Mater. Eng. 2014, 299, 932-938; WO2013131079A1). Any of these objects can be recycled and used as fertilizers by means of the method of the invention after subjecting the product to a reacetylation if necessary.

Any material derived from chitin and/or chitosan used by different industries such as food (packaging materials, bags, etc.), biomedicine (capsules, pills, membranes, etc.) or others, could be similarly recycled.

### BRIEF DESCRIPTION OF THE FIGURES

FIG. 1. Analysis by means of Maldi-tof of the mixture obtained indicating the composition and the molecular weight of the oligosaccharides thereof. The peaks obtained in the analysis, and the corresponding molecular weights (m/z) of the oligosaccharides derived from the chitin obtained, are indicated.

FIG. 2. The increase in the total nitrogen content of Arabidopsis thaliana plants grown in a low-nitrogen medium, treated with the product (CHL) and with the mixture with a high molecular weight (CHH) after ten days of treatment, is shown compared to the controls with no treatment.

FIG. 3. The total carbon content of ecotype Columbia (Col-0) Arabidopsis thaliana seedlings, treated with the product (CHL) and with the mixture with a high molecular weight (CHH), after twenty days of growth in a controlled medium in “in vitro” laboratory conditions, is shown compared to plants with no treatment, grown in the same conditions.

FIG. 4. The increase of the fresh weight of ecotype Columbia (Col-0) Arabidopsis thaliana plants, treated with the product (CHL) and with the mixture with a high molecular weight (CHH) and without treatment after 20 days of growth, in a controlled medium in “in vitro” laboratory conditions, is shown.

### PREFERRED EMBODIMENTS

### Example 1. Obtaining a Composition Comprising Oligosaccharides in Accordance with the Method of the Invention

As a starting material, purified powder composed of ultrapure Sigma #C9752 chitin (Sant Louis, Mo., USA), with a level of acetylation of 95% (Batch No.: 107K7005V), derived from shrimp shells, and composed of Poly(N-acetyl-D-glucosamine), Poly(1→4)-β-N-acetyl-D-glucosamine, with a molecular formula C₈H₁₅NO₆ and molecular weight of 221.2078, was used. The starter material was homogenized in a porcelain mortar until a mixture with a mealy texture was obtained and the powder was resuspended in distilled water (Milipore, MiliQ water) in a frosted and dark glass jar, at a concentration of 100 mg/l, a volume of 5 ml of each solution was prepared.

The solution was autoclaved during 20 minutes at 121° C. (P-Selecta autoclave). The product is left to cool at room temperature, after which it is subjected to a sonication process at a power of 50 Hz in a water bath during 5 minutes at a temperature no greater than 25° C.

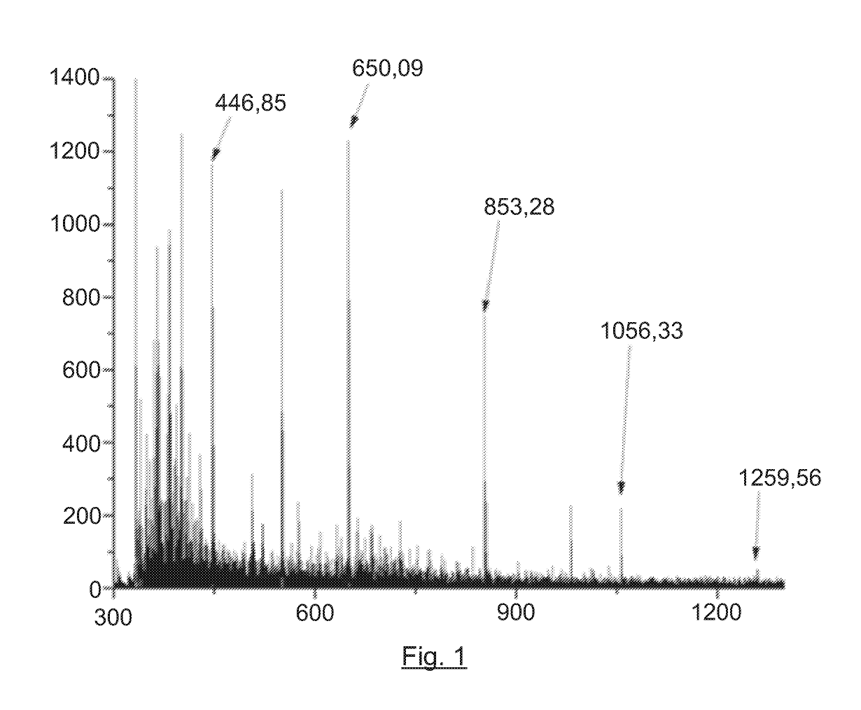

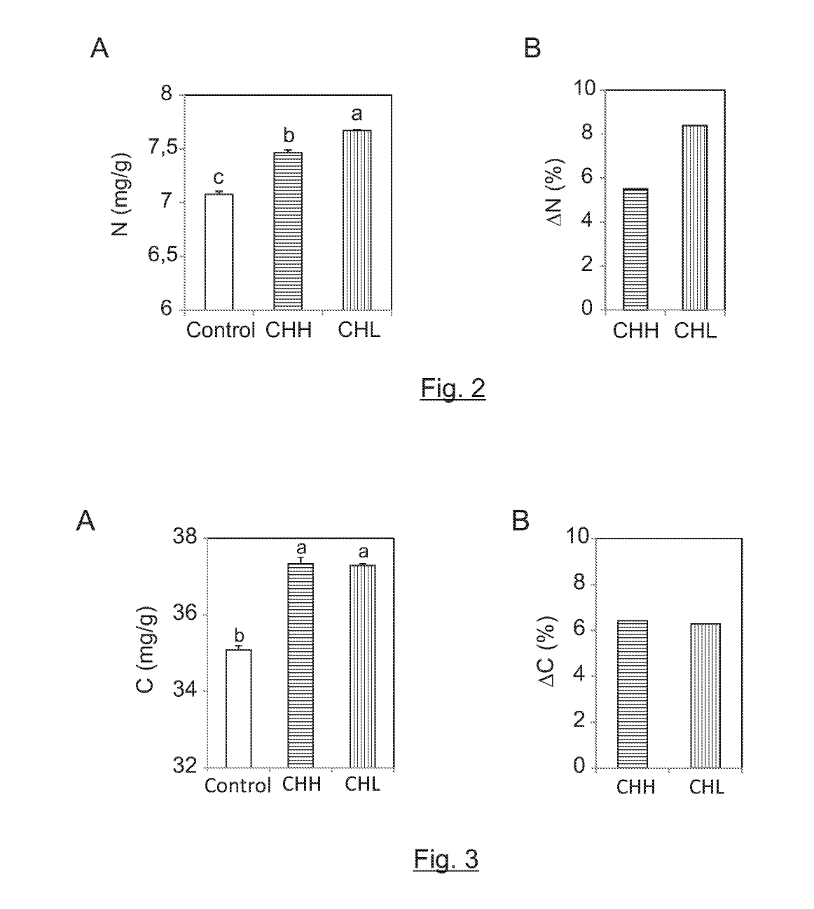

The product was stored at room temperature no greater than 25° C. or at 4° C. if it was not used the same day. A Maldi-Tof analysis of the product obtained was carried out. The results are shown in Table 1 and in FIG. 1.

TABLE 1
Results of the Maldi-Tof analysis. The peaks obtained in the analysis
are indicated, which correspond to the molecular weights (m/z) of the
oligosaccharides derived from the chitin, in acetylated state (A), A2
corresponding to the dimer, A3 to the trimer, A4 to the tetramer, A5 to
the pentamer and A6 to the hexamer of chitin, indicating the intensity
of each oligosaccharide in the mixture and the percentage
corresponding of each one inside the mixture, according to the
intensity thereof. The theoretical molecular weights are indicated,
depending on the adduct formed with the Na⁺ ion.

| | theoretical m/z | | | |
|---|---|---|---|---|
| m/z obtained | [MNa⁺] | name | intensity | % |
| 446.85 | 447.16 | A2 | 1166 | 34.53 |
| 650.09 | 650.24 | A3 | 1203 | 35.63 |
| 853.28 | 853.31 | A4 | 750 | 22.21 |
| 1056.33 | 1056.39 | A5 | 219 | 6.48 |
| 1259.56 | 1259.47 | A6 | 38 | 1.12 |

### Example 2. Growth Trials of Arabidopsis thaliana Plants

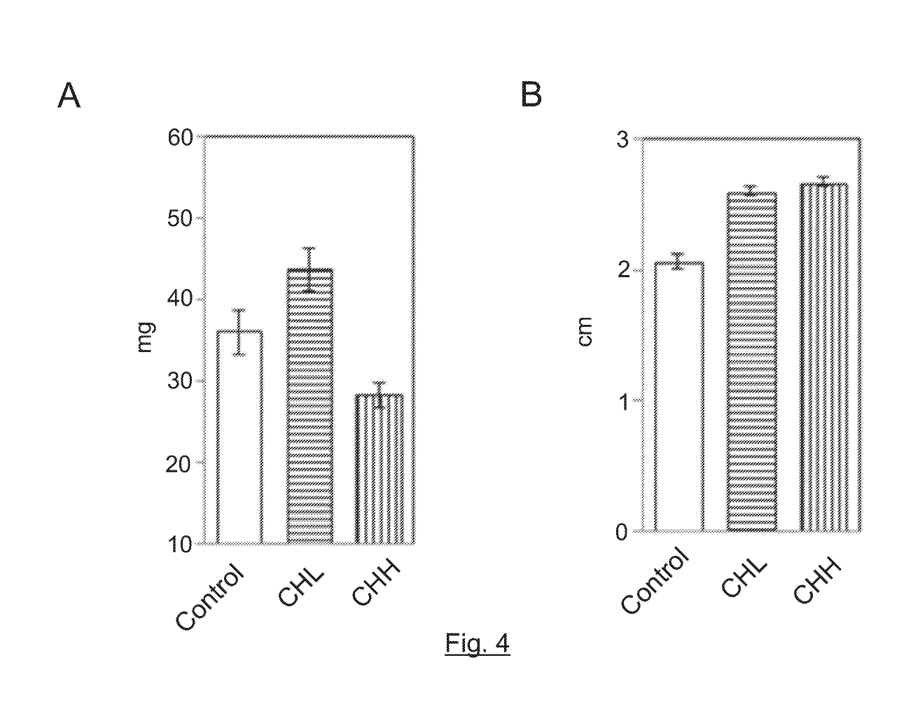

The product obtained in example 1, sterile and resuspended in water was applied at a concentration of 50 mg/l and 100 mg/l (addition at a temperature less than 65° C.) on a hot sterile liquid medium, containing Murashige&Skoog (No. #16-M0233, Duchefa Biochemie, NY, USA), which contains half the standard nitrogen supplied to obtain a growth suitable for these plants and bacteriological Agar at a concentration of 9 g/l and 1% of Sacarosa (weight/volume), the pH of the medium is adjusted to 5.75 with diluted hydrochloric acid. A volume of between 30-40 ml of this medium was applied on square Petri® dishes until it is solid. 120 ecotype Columbia Arabidopsis thaliana seeds were placed on each dish, placed in three rows of 40 seeds in each one. Said seeds were previously sterilised by means of a treatment of 20 minutes with a solution containing Tween® 20 and sodium hypochlorite, after which they were cleaned three times with sterile distilled water. Once sterilized, the seeds inside the dishes and covered with aluminium foil were stratified, with the aim of synchronising the germination thereof, for which reason they were subjected to a temperature of 4° C. in darkness during two days, after which the dishes were placed in vertical supports and were germinated and grown, until 21 days, in a growth chamber controlled in cycles at 23° C. during 16 hours of light and 20° C. during 8 hours of darkness, with a constant relative humidity of 60% and under light intensity of between 100-150 mE/m² using Growlux®-type fluorescent light tubes. The values of the main root length of each plant were taken at different times. The increase in fresh weight of the plants treated and untreated with the product, as well as with the same mixture of the product without treatment was estimated. An increase in the growth of the main root of the plants treated was estimated to range between 5 and 25% with respect to the control plants depending on the experiment and the plant variability (FIG. 4). An increase in the development of lateral roots in the control plants, which are not treated with the product was also observed with respect to the treated plants, which is a symptom that tends to be associated to the lack of nutrients of the medium, and was not observed in plants treated with the product. It must be noted that the medium without product contains half the nitrogen usually used and that this stress response was not observed in plants treated with the product.

### Example 3. Determining the Nitrogen and Carbon Content in Arabidopsis thaliana Plants

The product obtained in example 1 was applied at a concentration of 50 mg/l and 100 mg/l on the growth medium described in example 2 in the dishes described in example 2. 300 ecotype Columbia Arabidopsis thaliana seeds were placed on each dish. Said seeds were previously sterilized and stratified as stated in example 2, after which the dishes were vertically placed and were germinated and grown, up to a maximum of 21 days, in a growth chamber controlled in cycles at 23° C. during 16 hours of light and 20° C. during 8 hours of darkness, with a constant relative humidity of 60% and under light intensity of between 100-150 mE/m² using Growlux®-type fluorescent light tubes. After the different growth times selected, the tissue of each dish was taken and left to dry in an oven between 65-70° C. during at least 48 hours. The tissues were finely ground and homogenized. The concentration of N and C was determined using a mass analyzer (LECO CHN-600) in accordance with the instructions of the manufacturer. In each block (3 squares), they were collected and grouped together in a sample of 12 plants per treatment.

The total nitrogen and carbon content in the plants treated were compared to those not treated, an increase of between 8 and up to 15% being detected after the first 14 days of growth in the plants supplemented with the product with respect to those that are not supplemented. This value could vary depending on the molecular weight of the mixture of the treatment (CHL: Mixture of chitin with a low molecular weight obtained by means of the protocol described in example 1 or CHH: Commercial ultrapure chitin with a high molecular weight, from shrimp shell with a high molecular weight Sigma #C9752 with a purity of 99% and a level of acetylation of at least 95%).

After 20 days of growth, no differences were observed in the nitrogen content or carbon content in the supplemented plants, it being possible to determine that in the range of concentrations used and under these conditions, the plants have consumed essentially all the product that they can capture in the growth medium.

### Example 4. Growth Trials of Populus tricocarpa Plants

Populus tricocarpa explants grown during 45 days in a standard medium, that is not supplemented, were transferred to the medium used in example 1 supplemented with the product obtained in example 1, as described in example 2. Each explant measured between three and four centimeters in length and contained one leaf.

The trees were transplanted into glass tubes that are 2.7 cm wide by 14 cm high, containing the medium described in example 2. The growth parameters were monitored by measuring the main root and the stalk over different weeks, up to a maximum of three months, an increase in root growth of up to 8% being observed in plants supplemented with the product with respect to the control plant not supplemented.

1. A method of stimulating plant growth in already germinated plants comprising: applying oligosaccharides comprising N-acetyl glucosamine to an already germinated plants, wherein the percentage of N-acetyl glucosamine in said oligosaccharides is 100% and in that the length of said oligosaccharides is between 1 and 6 monosaccharides.

2. A method for obtaining oligosaccharides composed of N-acetyl glucosamine as stimulators of plant growth in already germinated plants, wherein the percentage of N-acetyl glucosamine in said oligosaccharides is 100%, in that the length of said oligosaccharides is between 1 and 6 monosaccharides and in that the method comprises the following stages:
(a) resuspending chitin with a percentage of N-acetyl glucosamine of between 95% and 100% in water,
(b) heating the resulting composition of stage (a) to a temperature of between 120 and 180° C. for a duration of between 20 and 40 minutes and leaving to cool to room temperature, and
(c) sonicating the resulting composition of stage (b) at a power of between 50 and 60 Hz for a duration of between 5 and 120 minutes at a temperature of between 20 and 25° C.

3. The method according to claim 2, wherein in stage (a) the chitin is resuspended at a concentration between 0.04 to 4 g/l.

4. The method according to claim 2, wherein the resulting composition of stage (c) is subjected to a drying process.

5. The method according to claim 3, wherein the resulting composition of stage (c) is subjected to a drying process.
